(19) United States
(12) Patent Application Publication
(10) Pub. No.: US 2007/0243441 A1
(43) Pub. Date: Oct. 18, 2007

(54) Fuel Cell and Fuel Cell Stack

(75) Inventor: Tadashi Tsunoda, Tokyo (JP)

Correspondence Address: LAHIVE & COCKFIELD, LLP, ONE POST OFFICE SQUARE, BOSTON, MA, 02109-2127, US

(73) Assignee: Honda Motor Co., Ltd., Tokyo (JP)

(21) Appl. No.: 11/547,877

(22) PCT Filed: Apr. 5, 2005
(86) PCT No.: PCT/JP05/06984

§ 371 Date: Oct. 5, 2006

(30) Foreign Application Priority Data
Apr. 5, 2004 (JP) 2004-110663

(51) Int. Cl. H01M 4/02

(52) U.S. Cl. 429/27

(57) ABSTRACT

In the fuel cell, eight electrolyte electrode assemblies are sandwiched between a pair of separators. The separator includes a first plate, a second plate, and a third plate, the first plate stacked on the third plate, and the third plate stacked on the second plate. A fuel gas channel connected to a fuel gas supply passage is formed between the first and third plates. The fuel gas channel forms a fuel gas pressure chamber between a first circular disk of the first plate and a third circular disk of the third plate. Further, an oxygen-containing gas channel open to the outside is formed between the second and third plates. The oxygen-containing gas channel forms an oxygen-containing gas pressure chamber between the second and third circular disks.

### TECHNICAL FIELD

The present invention relates to a fuel cell formed by sandwiching a plurality of electrolyte electrode assemblies between a pair of separators. Each of the electrolyte electrode assemblies includes an anode, a cathode, and an electrolyte interposed between the anode and the cathode. Further, the present invention relates to a fuel cell stack including the fuel cell.

### BACKGROUND ART

A solid oxide fuel cell (SOFC) employs an electrolyte of ion-conductive solid oxide such as stabilized zirconia. The electrolyte is interposed between an anode and a cathode to form an electrolyte electrode assembly. In an SOFC, generally, the electrolyte electrode assembly is interposed between separators (bipolar plates) to form a unit cell. In use, a predetermined numbers of the unit cells and the separators are stacked together to form a fuel cell stack.

In such an SOFC, when an oxygen-containing gas or air is supplied to the cathode, the oxygen in the oxygen-containing gas is ionized at the interface between the cathode and the electrolyte, and the oxide ions (O²⁻) are generated. The generated oxygen ions move toward the anode through the electrolyte.

Also, a fuel gas such as a hydrogen-containing gas or CO is supplied to the anode. Oxide ions react with the hydrogen to produce water or react with CO to produce CO₂. Electrons released in the reaction flow through an external circuit to the cathode, creating a DC electric energy.

For example, the electric energy generated in the electrolyte electrode assembly is transmitted to terminal plates through a current collector provided in the separator. Therefore, the desired contact state between the current collector and the electrolyte electrode assembly needs to be maintained. However, variation in the height of the current collector or the thickness of the electrolyte electrode assembly occurs easily due to factors such as fabrication accuracy. In particular, since the rigidity of the current collector is high, the electrolyte electrode assembly may be damaged undesirably.

In an attempt to address the problem, for example, Japanese Laid-Open Patent Publication No. 2001-68132 discloses a solid oxide fuel cell. As shown in FIG. 15, according to the disclosure of Japanese Laid-Open Patent Publication No. 2001-68132, a plurality of solid oxide fuel cells 1 are stacked together. The solid oxide fuel cell 1 includes a flat unit cell 2, a first spacer 3, a second spacer 4, and a current collecting plate 5. The current collecting plate 5 includes a flat metal plate 6, and thin metal plates 7 provided on both surfaces of the flat metal plate 6. Projections 7a are formed on the thin metal plates 7. The projections 7a contact the surface of a fuel electrode or an air electrode of the unit cell 2.

According to the disclosure, the projections 7a have the suitable elasticity. Therefore, even if an excessive force is applied to the projections 7a, the projections 7a are deformed suitably, and absorb the applied load for preventing the damage of the fuel electrode or the air electrode which contacts the projections 7a.

However, in Japanese Laid-Open Patent Publication No. 2001-68132, the current collecting plate 5 includes the flat metal plate 6 and the thin metal plates 7 attached on both surfaces of the flat metal plate 6. The thin metal plates 7 provided on both surfaces of the metal plate 6 have the projections 7a, respectively. Since the thin metal plates 7 have the elasticity, the surface pressure is small at portion of the current collector which is deformed to a small extent, and the surface pressure is large at portion of the current collector which is deformed to a large extent. Thus, the surface pressure in the current collector is not uniform.

Further, though the elasticity of the thin metal plates 7 is utilized, the elasticity may be lowered by the influence of heat or the like. Thus, the desired stress absorption function may not be achieved.

Furthermore, deformation of the thin metal plates 7 due to the change in the elasticity would result in the non-uniform shapes of the respective fluid passages. In this case, it is difficult to achieve the uniform flows of the reactant gases or the like.

Still further, to generate a large amount of electric energy, it is preferable to employ an electrolyte electrode assembly having a large area. In this case, however, the difference in the surface pressure may also be increased undesirably, as well as making it harder to achieve the uniform flows of the reactant gases or the like.

For obtaining a large amount of electric energy, a plurality of electrolyte electrode assemblies may be employed. In this case, also, it is difficult to achieve the uniform flows of reactant gases in each electrolyte electrode assembly.

### DISCLOSURE OF INVENTION

A general object of the present invention is to provide a fuel cell which makes it possible to maintain the uniform surface pressure applied between an electrolyte electrode assembly and current collectors.

A main object of the present invention is to provide a fuel cell which makes it possible to achieve the uniform flows of reactant gases.

Another object of the present invention is to provide a fuel cell which generates a large amount of electric energy.

A still another object of the present invention is to provide a fuel cell stack including the fuel cell.

According to an aspect of the present invention, a fuel cell includes a plurality of electrolyte electrode assemblies sandwiched between a pair of separators. Each of the electrolyte electrode assemblies includes an anode, a cathode, and an electrolyte interposed between the anode and the cathode.

Each of the separators includes first and second plates which are stacked together.

A fuel gas channel for supplying a fuel gas to the anode, and an oxygen-containing gas channel for supplying an oxygen-containing gas to the cathode are formed between the first and second plates.

The fuel gas channel is provided over an electrode surface of the anode, and the first plate is interposed between the fuel gas channel and the anode to form a fuel gas pressure chamber such that the first plate tightly contacts the anode under pressure when the fuel gas is supplied into the fuel gas pressure chamber.

The oxygen-containing gas channel is provided over an electrode surface of the cathode, and the second plate is interposed between the oxygen-containing gas channel and the cathode to form an oxygen-containing gas pressure chamber such that the second plate tightly contacts the cathode under pressure when the oxygen-containing gas is supplied into the oxygen-containing gas pressure chamber.

The fuel gas is supplied individually to the respective anodes of the electrolyte electrode assemblies, and the oxygen-containing gas is supplied individually to the respective cathodes of the electrolyte electrode assemblies.

That is, according to the present invention, a plurality of unit cells are present in the same plane. With the structure, it is possible to generate a large amount of electric energy.

According to the present invention, when the fuel gas supplied to the fuel gas channel flows into the fuel gas pressure chamber, the internal pressure in the fuel gas pressure chamber is increased, and the first plate of the fuel gas chamber is expanded such that the first plate tightly contacts the anode under pressure. Likewise, when the oxygen-containing gas supplied to the oxygen-containing gas channel flows into the oxygen-containing gas pressure chamber, the internal pressure in the oxygen-containing gas pressure chamber is increased, and the second plate of the oxygen-containing gas chamber is expanded such that the second plate tightly contacts the cathode under pressure.

Therefore, dimensional variations of the separator and the electrolyte electrode assembly are absorbed. It is possible to maintain the uniform surface pressure applied between the electrolyte electrode assembly and the first and second plates as the current collectors. Further, the current collectors tightly contact the entire surfaces of the electrodes of the electrolyte electrode assembly with the uniform surface pressure. The contact resistances of the current collectors are reduced. Thus, improvement in the power generation efficiency is achieved.

Further, since the excessive surface pressure is not locally applied to the electrolyte electrode assemblies, the damage of the electrolyte electrode assemblies is prevented desirably. Further, the required surface pressure for tightening the electrolyte electrode assemblies is generated without any external tightening means.

Moreover, uniform shapes of the respective fluid passages formed between the electrolyte electrode assemble and current collectors are maintained. Thus, the flows of the reactant gases or the like are uniform, and improvement in the power generation efficiency is achieved.

Further, with the structure, the pressures in all of the respective fuel gas pressure chambers are the same, and the pressures in all of the respective oxygen-containing gas pressure chambers are the same. Therefore, the amounts of the reactant gases supplied to all of the respective electrolyte electrode assemblies at the fuel gas pressure chambers and at the oxygen-containing gas pressure chambers are the same. Stated otherwise, since the same amounts of the reactant gases are supplied to all of the unit cells, the uniform power generation performance in the unit cells is achieved.

Further, since the pressure chambers are connected by bridges, the unit cells are arranged in an arbitral shape depending on the application.

A plurality of fuel gas pressure chambers and a plurality of oxygen-containing gas pressure chambers corresponding to the number of the electrolyte electrode assemblies may be provided individually, and adjacent pressure chambers may be connected with each other. In this case, the electrolyte electrode assemblies are provided separately at positions of the fuel gas pressure chambers and the oxygen-containing gas pressure chambers.

With the structure, the pressures of the individual pressure chambers are the same. Stated otherwise, the uniform pressure is achieved in all of the unit cells. Therefore, the same amounts of the reactant gases are supplied to the respective electrolyte electrode assemblies. Thus, variation of the power generation performance between the unit cells is reduced.

Since the pressure chambers are connected with each other, it is possible to arrange the unit cells in an arbitral shape. Therefore, the fuel cell having the desired shape is produced depending on the application.

The first plate may have a fuel gas inlet for supplying the fuel gas from the fuel gas pressure chamber toward a central region of the anode, and the second plate may have an oxygen-containing gas inlet for supplying the oxygen-containing gas from the oxygen-containing gas pressure chamber toward a central region of the cathode. In this case, the fuel gas and the oxygen-containing gas flow from the central regions of the electrodes toward the outer regions of the electrodes. Therefore, reactions occur over the entire surface of the electrodes. Accordingly, improvement in the power generation efficiency in the unit cells is achieved.

Further, it is preferable that a third plate is provided between the first and second plates for dividing a space between the first and the second plates into the fuel gas channel and the oxygen-containing gas channel. Thus, it is possible to reliably separate the fuel gas channel and the oxygen-containing gas channel.

In this case, it is preferable that a fuel gas distribution passage for connecting a fuel gas supply passage and the fuel gas channel is formed between the first and third plates, and the fuel gas before consumption is supplied through the fuel gas supply passage in the stacking direction of the electrolyte electrode assembly and the separators, and it is preferable that an oxygen-containing gas distribution passage for connecting an oxygen-containing gas supply passage and the oxygen-containing gas channel is formed between the second and third plates, and the oxygen-containing gas before consumption is supplied through the oxygen-containing gas supply passage in the stacking direction. The gas channel and the gas distribution passage are formed in the same plane to reduce the thickness of the fuel cell in the stacking direction.

Further, it is preferable that the separator further comprises an exhaust gas channel for discharging the oxygen-containing gas and the fuel gas supplied to, and consumed in reactions in the electrolyte electrode assembly as an exhaust gas in the stacking direction of the electrolyte electrode assembly and the separators, and a fuel gas channel member for forming the fuel gas channel and supporting the electrolyte electrode assembly, and an oxygen-containing gas channel member for forming the oxygen-containing gas channel and supporting the electrolyte electrode assembly are provided in the exhaust gas channel.

In this case, the exhaust gas contacts the separators. Therefore, the temperature of the electrolyte electrode assemblies is increased by the waste heat of the exhaust gas. Stated otherwise, the waste heat of the exhaust gas is utilized for preheating the electrolyte electrode assemblies. Therefore, it is possible to reduce the size of heating means used in operation of the fuel cell. As a result, the size of the fuel cell system is reduced.

In any of the cases, it is preferable that the first and second plates include first and second protrusions protruding in different directions, and the first protrusion of one of the separators and the second protrusion of the other of the separators sandwich the electrolyte electrode assembly. With the structure, it is possible to reliably form the passages for supplying the reactant gases to the electrolyte electrode assembly.

Further, it is preferable that the first and second protrusions function as current collectors for collecting electric energy generated in the electrolyte electrode assembly. Therefore, improvement in the efficiency of collecting the electric energy is achieved.

Further, it is preferable that the third plate has a third protrusion protruding toward the first plate.

According to another aspect of the present invention, a fuel cell stack includes a plurality of fuel cells stacked together, and end plates provided at opposite ends in a stacking direction of the fuel cells. Each of the fuel cells includes a plurality of electrolyte electrode assemblies sandwiched between a pair of separators. Each of the electrolyte electrode assemblies includes an anode, a cathode, and an electrolyte interposed between the anode and the cathode.

Each of the separators includes first and second plates which are stacked together.

A fuel gas channel for supplying a fuel gas to the anode, and an oxygen-containing gas channel for supplying an oxygen-containing gas to the cathode are formed between the first and second plates.

The fuel gas channel is provided over an electrode surface of the anode, and the first plate is interposed between the fuel gas channel and the anode to form a fuel gas pressure chamber such that the first plate tightly contacts the anode under pressure when the fuel gas is supplied into the fuel gas pressure chamber.

The oxygen-containing gas channel is provided over an electrode surface of the cathode, and the second plate is interposed between the oxygen-containing gas channel and the cathode to form an oxygen-containing gas pressure chamber such that the second plate tightly contacts the cathode under pressure when the oxygen-containing gas is supplied into the oxygen-containing gas pressure chamber.

The fuel gas is supplied individually to the respective anodes of the electrolyte electrode assemblies, and the oxygen-containing gas is supplied individually to the respective cathodes of the electrolyte electrode assemblies.

That is, the fuel cell stack is formed by stacking a plurality of the fuel cells. In this manner, the fuel cell stack formed by stacking the fuel cells is used in practical applications.

It is a matter of course that a plurality of fuel gas pressure chambers and a plurality of oxygen-containing gas pressure chambers corresponding to the number of the electrolyte electrode assemblies may be provided individually, adjacent pressure chambers may be connected with each other, and the electrolyte electrode assemblies may be provided separately at positions of the fuel gas pressure chambers and the oxygen-containing gas pressure chambers.

According to the present invention, since a plurality of unit cells are present in the same plane, a large amount of electric energy is generated. Since the pressures of the individual pressure chambers are the same, the same amounts of the reactant gases are supplied to the respective unit cells. Thus, variation of the performance between the unit cells is reduced.

The internal pressure in the fuel gas pressure chamber and the internal pressure in the oxygen-containing gas pressure chamber are increased to expand the first and second plates such that the plates tightly contact the anode and the cathode under pressure. Therefore, it is possible to maintain the uniform surface pressure applied between the electrolyte electrode assembly and the first and second plates as the current collectors. That is, variation of the surface pressure is prevented.

The uniform shapes of the fluid passages formed between the electrolyte electrode assemblies and the current collectors are maintained. Thus, uniform flows of the reactant gases, and improvement in the power generation efficiency are achieved.

The above and other objects, features and advantages of the present invention will become more apparent from the following description when taken in conjunction with the accompanying drawings in which preferred embodiments of the present invention are shown by way of illustrative example.

### BRIEF DESCRIPTION OF DRAWINGS

FIG. 1 is a perspective view schematically showing a fuel cell stack formed by stacking a plurality of fuel cells according to a first embodiment;

FIG. 2 is a cross sectional view showing part of a fuel cell system in which the fuel cell stack is disposed in a casing;

FIG. 3 is an exploded perspective view showing a separator of a fuel cell in FIG. 1;

FIG. 4 is a partial exploded perspective view showing gas flows in the fuel cell;

FIG. 5 is a view showing one surface of a third plate of the separator in FIG. 3;

FIG. 6 is an enlarged cross sectional view showing a region near a fuel gas supply passage of the fuel cell in FIG. 1;

FIG. 7 is an enlarged cross sectional view showing an outer circumferential region of the fuel cell in FIG. 1;

FIG. 8 is a cross sectional view schematically showing operation of the fuel cell in FIG. 1;

FIG. 9 is a perspective view schematically showing a fuel cell stack formed by stacking a plurality of fuel cells according to a second embodiment;

FIG. 10 is an exploded perspective view showing a separator of the fuel cell in FIG. 9;

FIG. 11 is a cross sectional view schematically showing operation of the fuel cell in FIG. 9;

FIG. 12 is a plan view showing a fuel cell stack in FIG. 9 as viewed from an end plate;

FIG. 13 is a view showing one surface of a third plate of a separator of a fuel cell according to a third embodiment;

FIG. 14 is a view showing one surface of a first plate of a separator of a fuel cell according to a fourth embodiment; and

FIG. 15 is a cross sectional view showing a solid oxide fuel cell disclosed in Japanese Laid-Open Patent Publication No. 2001-68132.

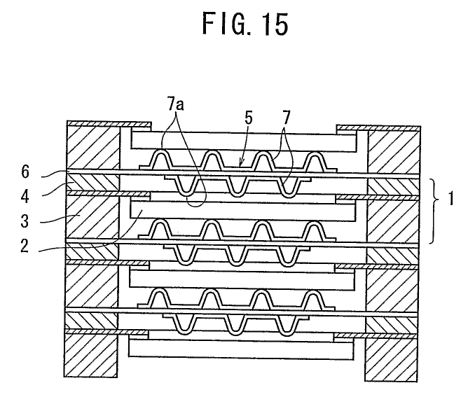

### BEST MODE FOR CARRYING OUT THE INVENTION

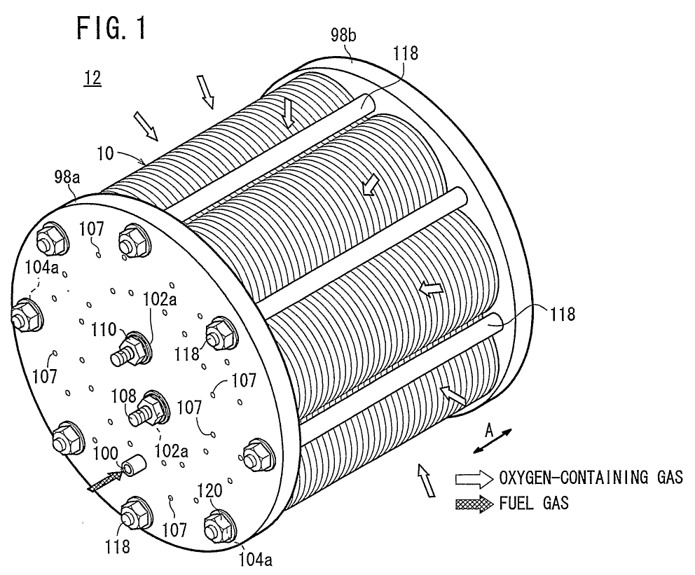

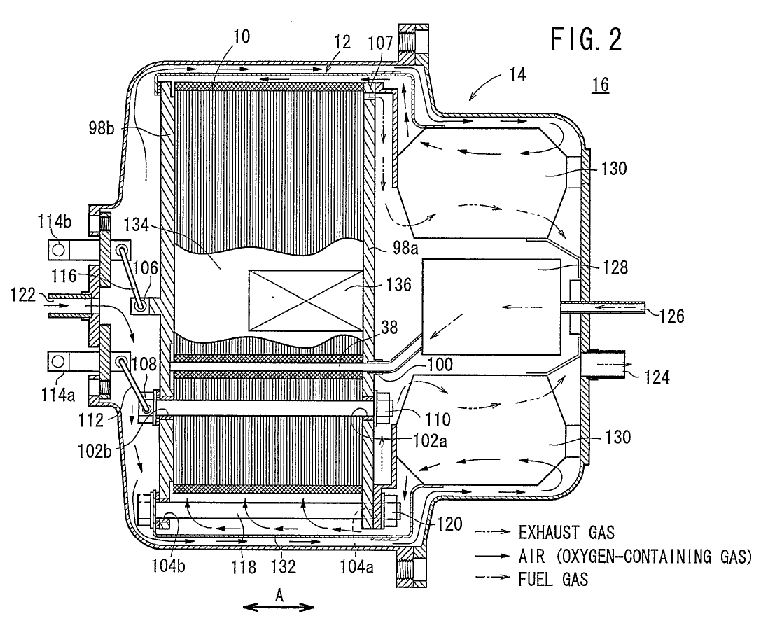

FIG. 1 is a perspective view schematically showing a fuel cell stack 12 formed by stacking a plurality of fuel cells 10 according to a first embodiment of the present invention in a direction indicated by an arrow A. FIG. 2 is a cross sectional view showing part of a fuel cell system 16 in which the fuel cell stack 12 is disposed in a casing 14.

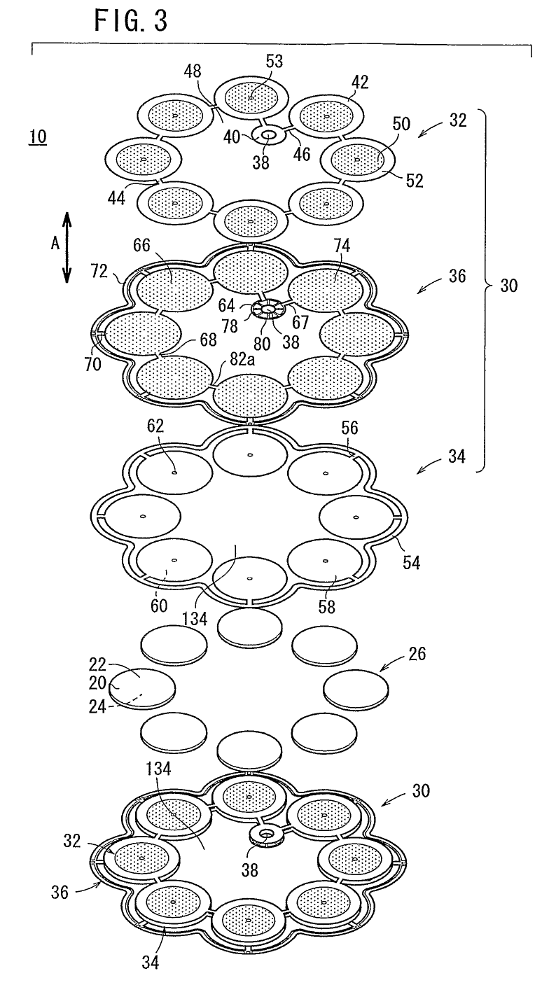

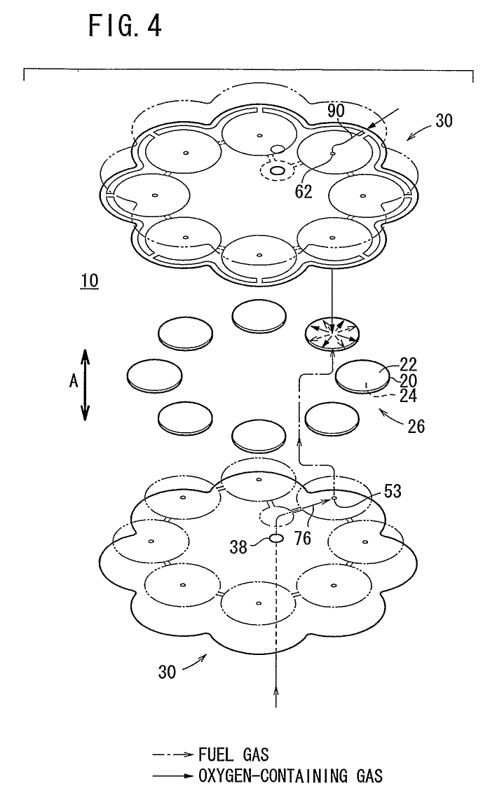

As shown in FIGS. 3 and 4, one fuel cell 10 includes eight electrolyte electrode assemblies 26 each having a circular disk shape. Each of the electrolyte electrode assemblies 26 includes a cathode 22, an anode 24, and an electrolyte (electrolyte plate) 20 interposed between the cathode 22 and the anode 24. For example, the electrolyte 20 is made of ion-conductive solid oxide such as stabilized zirconia. That is, the fuel cell 10 is a solid oxide fuel cell (SOFC). The fuel cell stack 12 is used in various applications, including stationary and mobile applications. For example, the fuel cell stack 12 is mounted in a vehicle. The eight electrolyte electrode assemblies 26 are arranged along one virtual circle at equal angles (intervals) of 45°.

In the fuel cell 10, the eight electrolyte electrode assemblies 26 are sandwiched between a pair of separators 30. That is, the fuel cell 10 according to the first embodiment includes the eight electrolyte electrode assemblies 26 sandwiched between the pair of separators 30 to form eight unit cells. Also in the other embodiments as described later, a plurality of electrolyte electrode assemblies 26 are sandwiched between a pair of separators 30.

Each of the separators 30 includes first and second plates 32, 34 which are stacked together, and a third plate 36 interposed between the first and second plates 32, 34. For example, the first through third plates 32, 34, 36 are metal plates of, e.g., stainless alloy.

The first plate 32 has a first small diameter end portion 40. A fuel gas supply passage 38 extends through the center of the first small diameter end portion 40. Further, the first plate 32 includes eight first circular disks 42 having a relatively large diameter. The first circular disks 42 are arranged along the virtual circle at equal intervals, and are connected together by narrow bridges 44. The first circular disk 42 and the anode 24 of the electrolyte electrode assembly 26 have substantially the same size.

The first small diameter end portion 40 is positioned near two of the eight first circular disks 42, and connected to the two first circular disks 42 by bridges 46. Stated otherwise, the first small diameter end portion 40 is provided at a position deviated from the center concentric with the virtual circle passing through the eight first circular disks 42.

Further, an exhaust gas channel 48 is formed by the outer curved portions (but internally positioned) of the first circular disks 42. Further, each of the first circular disks 42 has a plurality of first protrusions 50 and a ring shaped protrusion 52 on a surface which contacts the anode 24 of the electrolyte electrode assembly 26. The first protrusions 50 and the ring shaped protrusion 52 jointly function as a current collector. The first protrusions 50 may be formed by making a plurality of recesses in a surface which is in the same plane with the surface of the ring shaped protrusion 52.

A fuel gas inlet 53 is provided at the center of the first circular disk 42 for supplying the fuel gas toward substantially the central region of the anode 24.

The second plate 34 has a curved outer section 54. Respective circular arc portions of the curved outer section 54 are integral with second circular disks 58 through bridges 56 extending internally from the circular arc portions. The diameter of the second circular disk 58 corresponds to the diameter of the first circular disk 42. The eight circular disks 58 are provided at positions corresponding to the positions of the first circular disks 42. Further, each of the second circular disks 58 has a plurality of second protrusions 60 on a surface which contacts the cathode 22 of the electrolyte electrode assembly 26. An oxygen-containing gas inlet 62 is provided at the center in each of the second circular disks 58.

The third plate 36 includes a second small diameter end portion 64 and third circular disks 66 each having a relatively large diameter. The second small diameter end portion 64 is provided at a position corresponding to the position of the first small diameter end portion 40. The fuel gas supply passage 38 extends through the center of the second small diameter end portion 64. The third circular disks 66 are provided at positions corresponding to the positions of the first circular disks 42 and the second circular disks 58. The third circular disks 66 are arranged at equal angles (intervals). The second small diameter end portion 64 is connected to two of the third circular disks 66 by bridges 67, and the other third circular disks 66 are connected with each other in an annular shape by bridges 68. Further, the third circular disks 66 are connected to an outer curved section 72 by bridges 70.

A plurality of third protrusions 74 are formed in the entire surface of the third circular disk 66 facing the first plate 32, and the third protrusions 74 are part of a fuel gas channel 76 shown in FIG. 4.

Further, a plurality of slits 78 are formed radially in the second small diameter end portion 64, on a surface facing the first plate 32. The slits 78 are connected to the fuel gas supply passage 38. Further, the slits 78 are connected to a recess 80 formed in an outer circumferential region of the second small diameter end portion 64. The recess 80 prevents the entry of brazing material into the slits 78, and into an area inside the recess 80.

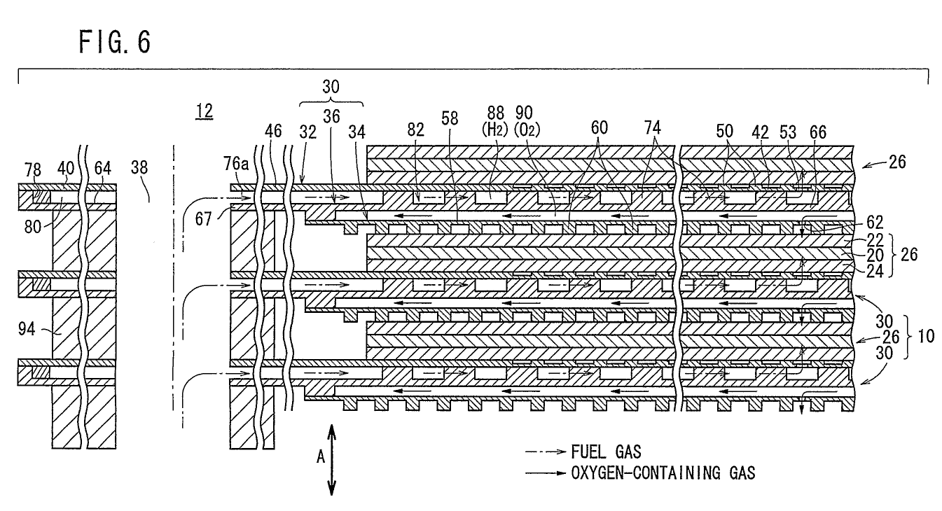

A fuel gas distribution passage 76a (see FIG. 6) as part of a fuel gas channel 76 is formed in the bridge 67. The fuel gas distribution passage 76a is connected to the feel gas supply passage 38 through the slits 78. The fuel gas channel 76 is formed in the surfaces of the bridges 68, 70, and the third circular disks 66.

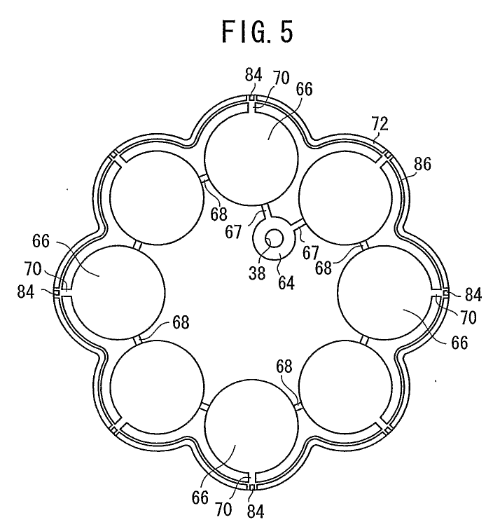

As shown in FIG. 5, the curved outer section 72 of the third plate 36 has a plurality of slits 84 as air intake passages at positions corresponding to the respective third circular disks 66, on a surface facing the second plate 34. Further, a recess 86 for preventing the flow of brazing material is formed along the profile of the curved outer section 72.

When the bridge 44 of the first plate 32 and the bridge 68 of the third plate 36 are joined together by brazing to form a fuel gas channel member, as shown in FIG. 6, the fuel gas channel 76 including the fuel gas distribution passage 76a is formed in the fuel gas channel member. Further, the fuel gas channel 76 includes a pressure chamber 88 between the first circular disk 42 and the third circular disk 66.

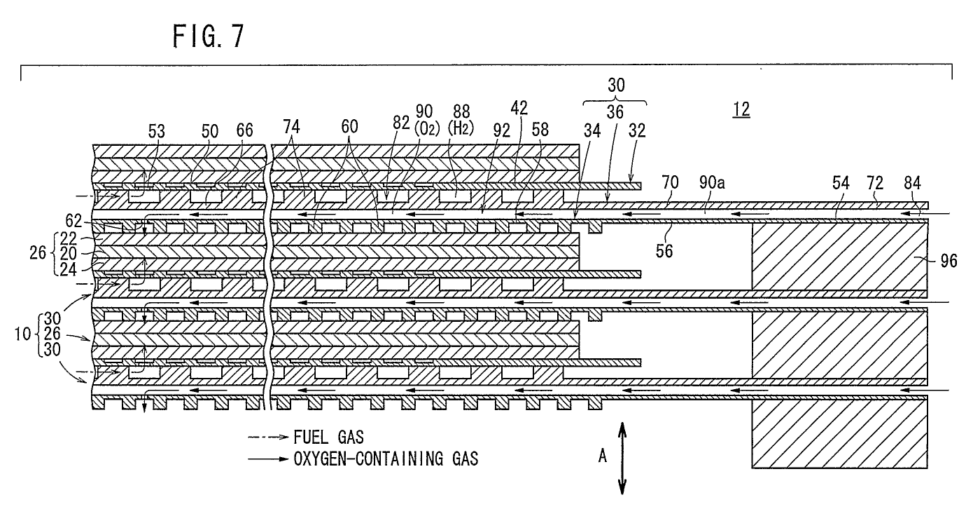

When the bridge 56 of the second plate 34 and the bridge 70 of the third plate 36 are joined together by brazing to form an oxygen-containing gas channel member, as shown in FIG. 7, an oxygen-containing gas channel 90 including an oxygen-containing gas distribution passage 90a is formed in the oxygen-containing gas channel member. Further, the oxygen-containing gas channel 90 includes an oxygen-containing gas pressure chamber 92 between the second circular disk 58 and the third circular disk 66.

As shown in FIG. 6, insulating seals 94 for sealing the fuel gas supply passage 38 are provided between the separators 30. Further, as shown in FIG. 7, insulating seals 96 are formed between the curved outer sections 54, 72. For example, the insulating seals 94, 96 are made of mica material, or ceramic material.

As shown in FIGS. 1 and 2, the fuel cell stack 12 includes circular disk shaped end plates 98a, 98b provided at opposite ends of the fuel cells 10 in the stacking direction. The end plate 98a is insulated, and a fuel gas supply port 100 is formed at a position coaxial with the fuel gas supply passage 38 extending through each of the fuel cells 10. That is, the fuel gas supply port 100 is connected to the fuel gas supply passage 38.

The end plate 98a has two bolt insertion holes 102a. The bolt insertion holes 102a are provided in the exhaust gas channel 48 of the fuel cell stack 12. Further, the end plate 98a has eight bolt insertion holes 104a at positions between the respective adjacent electrolyte electrode assemblies 26.

The end plate 98b is made of electrically conductive material. As shown in FIG. 2, the end plate 98b has a connection terminal 106. The connection terminal 106 axially extends from the central region of the end plate 98b. Further, the end plate 98b has two bolt insertion holes 102b. The connection terminal 106 is positioned between the bolt insertion holes 102b. The bolt insertion holes 102a are in alignment with the bolt insertion holes 102b. Bolts 108 are inserted through the bolt insertion holes 102a, 102b, and tip ends of the bolts 108 are screwed into nuts 110. The bolts 108 are electrically insulated from the end plate 98b. Heads of the bolts 108 are connected electrically to an output terminal 114a through conductive wires 112, and the connection terminal 106 is electrically connected to an output terminal 114b through a conductive wire 116.

In FIGS. 1 and 2, reference numerals 107 denote exhaust ports for discharging the exhaust gas.

The end plate 98b has eight bolt insertion holes 104b in alignment with the bolt insertion holes 104a of the end plate 98a. Bolts 118 are inserted into the respective bolt insertion holes 104a, 104b, and tip ends of the bolts 118 are screwed into nuts 120.

The output terminals 114a, 114b are arranged in parallel, and are adjacent to each other. The output terminals 114a, 114b are fixed to the casing 14. The casing 14 has an air supply port 122 positioned between the output terminals 114a, 114b. Further, an exhaust port 124 is provided on the other end of the casing 14. A fuel gas supply port 126 is provided adjacent to the exhaust port 124. The fuel gas supply port 126 is connected to the fuel gas supply passage 38 through a reformer 128 as necessary. A heat exchanger 130 is provided around the reformer 128. A dual structure section 132 is provided in the casing 14, and the fuel cell stack 12 is disposed in the dual structure section 132.

The first small diameter end portion 40 and the second small diameter end portion 64 are positioned with deviation from the center of the fuel cell stack 12. Thus, a hole 134 is provided at the center of the fuel cell stack 12. In the embodiment, a start-up combustor 136 is provided in the hole 134.

Next, operation of the fuel cell stack 12 will be described below.

As shown in FIG. 3, in assembling the fuel cell 10, firstly, the first plate 32 and the second plate 34 are joined to both surfaces of the third plate 36 of the separator 30, e.g., by brazing. Further, the ring shaped insulating seal 94 is provided on the first plate 32 or the third plate 36 around the fuel gas supply passage 38 (see FIG. 6). Further, the curved insulating seal 96 is provided on the curved outer section 54 of the second plate 34 or the curved outer section 72 of the third plate 36 (see FIG. 7).

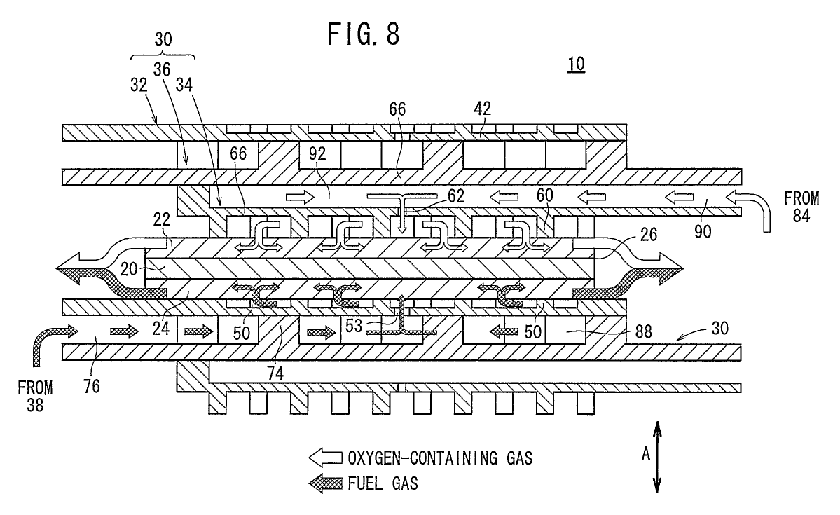

In this manner, the separator 30 is fabricated. As shown in FIG. 8, the third plate 36 divides a space between the first and second plates 32, 34 to form the fuel gas channel 76 and the oxygen-containing gas channel 90. Further, the fuel gas channel 76 is connected to the fuel gas supply passage 38 through the fuel gas distribution passage 76a, and the oxygen-containing gas channel 90 is open to the outside through the slit 84. Therefore, as shown in FIG. 1, the oxygen-containing gas is supplied from the outside of the fuel cell stack 12.

Then, the eight electrolyte electrode assemblies 26 are sandwiched between the separators 30. As shown in FIG. 3, the electrolyte electrode assemblies 26 are placed between the separators 30, i.e., between the first circular disks 42 of one separator 30 and the second circular disks 58 of the other separator 30. The fuel gas inlet 53 is positioned at the center in each of the anodes 24, and the oxygen-containing gas inlet 62 is positioned at the center in each of the cathodes 22.

The fuel cells 10 as assembled above are stacked in the direction indicated by the arrow A, and tightened together between the end plates 98a, 98b to form the fuel cell stack 12 (see FIG. 1). As shown in FIG. 2, the fuel cell stack 12 is mounted in the casing 14.

In starting operation of the fuel cell stack 12, firstly, the start-up combustor 136 is energized to assist warming up of the fuel cell stack 12 to the operating temperature.

As described above, in the first embodiment, the first small diameter end portion 40 and the second small diameter end portion 64 are remote from the center of the fuel cell stack 12. Therefore, it is possible to provide the hole (chamber) 134 centrally in the fuel cell stack 12. By providing the start-up combustor 136 in the hole 134 (the start-up combustor 136 is normally provided outside the casing 14), it is possible to =educe the size of the fuel cell system 16. Further, since the start-up combustor 136 warms up the fuel cell stack 12 rapidly, it is possible to achieve the predetermined power generation performance in each of the fuel cells 10. It is a matter of course that a device other than the start-up combustor 136 can be provided in the hole 134.

Then, the fuel gas is supplied into the fuel gas supply port 126 of the casing 14, and the air is supplied into the air supply port 122 of the casing 14. The fuel gas flows through the reformer 128 as necessary, and supplied into the fuel gas supply passage 38 of the fuel cell stack 12. The fuel gas flows in the stacking direction indicated by the arrow A, and flows through the fuel gas distribution passages 76a in the separator 30 of each fuel cell 10 (see FIG. 6).

The fuel gas flows along the fuel gas distribution passage 76a into the fuel gas pressure chamber 88 of the fuel gas channel 76. When the fuel gas flows through the small opening of the fuel gas inlet 53, the internal pressure in the fuel gas pressure chamber 88 is increased. As shown in FIGS. 4 and 8, the fuel gas from the fuel gas inlet 53 flows toward the central region of the anode 24 of the electrolyte electrode assembly 26. The fuel gas flows from the central region of the anode 24 to the outer circumferential region of the anode 24.

The oxygen-containing gas is supplied through the dual structure section 132 into the outer circumferential region in each of the fuel cells 10. The oxygen-containing gas flows through the slits 84 formed in the outer circumferential region in each of the separators 30, and is supplied to the oxygen-containing gas channel 90 (see FIG. 7). The oxygen-containing gas supplied to the oxygen-containing gas channel 90 flows into the oxygen-containing gas pressure chamber 92. When the oxygen-containing gas flows into the small opening of the oxygen-containing gas inlet 62, the internal pressure of the oxygen-containing gas in the oxygen-containing gas pressure chamber 92 is increased. The oxygen-containing gas from the oxygen-containing gas inlet 62 flows toward the central region of the cathode 22. The oxygen-containing gas flows from the central region of the cathode 22 of the electrolyte electrode assembly 26 to the outer circumferential region of the cathode 22 (see FIG. 8).

Therefore, in the electrolyte electrode assembly 26, the fuel gas is supplied from the central region to the outer circumferential region of the anode 24, and the oxygen-containing gas is supplied from the central region to the outer circumferential region of the cathode 22 (see FIG. 8). At this time, oxide ions flow toward the anode 24 through the electrolyte 20 for generating electricity by chemical reactions.

The fuel cells 10 are connected in series in the stacking direction indicated by the arrow A. As shown in FIG. 2, one of the poles is connected from the connection terminal 106 of the electrically conductive end plate 98b to the output terminal 114b through the conductive wire 116. The other pole is connected from the bolts 108 to the output terminal 114a through the conductive wires 112. Thus, the electric energy can be collected from the output terminals 114a, 114b.

In each of the fuel gas pressure chambers 88, the fuel gas is supplied to one electrolyte electrode assembly 26. Further, in each of the oxygen-containing gas pressure chambers 92, the oxygen-containing gas is supplied to one electrolyte electrode assembly 26. Thus, reactions occur at the anode 24 and the cathode 22 in all of the electrolyte electrode assemblies 26. After the fuel gas and the oxygen-containing gas are consumed in the reactions, the excessive fuel gas and the oxygen-containing gas flow toward the outer circumferential regions of the anode 24 and the cathode 22 in each of the electrolyte electrode assemblies 26, and are mixed together. The mixed gas is discharged as an exhaust gas.

The exhaust gas from the electrolyte electrode assemblies 26 is discharged through the outer circumferential regions of the first through third circular disks 42, 58, 66. The exhaust gas flows through the exhaust gas channel 48 in the separators 30 in the stacking direction, and discharged to the outside of the fuel cell stack 12 through the exhaust ports 107 of the end plate 98a. Then, the exhaust gas is discharged to the outside of the fuel cell system 16 through the exhaust port 124 of the casing 14.

In the first embodiment, the first and third plates 32, 36 are joined together to form the fuel gas fuel channel 76 connected to the fuel gas supply passage 38 between the first and third plates 32, 36. The fuel gas channel 76 forms the fuel gas pressure chamber 88 between the first and third circular disks 42, 66 which are joined together.

Therefore, the fuel gas supplied to the fuel gas channel 76 flows into the fuel gas pressure chamber 88. When the fuel gas flows through the small opening of the fuel gas inlet 53, the internal pressure in the fuel gas pressure chamber 88 is increased, and the fuel gas pressure chamber 88 is expanded to press the first circular disk 42 of the first plate 32 toward the anode 24 of the electrolyte electrode assembly 26 (see FIG. 8).

Likewise, the second and third plates 34, 36 are joined together to form the oxygen-containing gas channel 90 between the second and third plates 34, 36. Further, the oxygen-containing gas pressure chamber 92 is formed between the second and third circular disks 58, 66. Therefore, the oxygen-containing gas supplied to the oxygen-containing gas channel 90 flows into the oxygen-containing gas pressure chamber 92. When the oxygen-containing gas flows through the small opening of the oxygen-containing gas inlet 62, the internal pressure in the oxygen-containing gas pressure chamber 92 is increased, and the oxygen-containing gas pressure chamber 92 is expanded to press the second circular disk 58 of the second plate 34 toward the cathode 22.

Therefore, even in the presence of the dimensional variations of the separator 30 and the electrolyte electrode assembly 26, the entire surface of the first circular disk 42 tightly contacts the electrode surface of the anode 24, and the entire surface of the second circular disk 58 tightly contacts the electrode surface of the cathode 22. Thus, with the simple and compact structure, it is possible to maintain the uniform pressure applied between the electrolyte electrode assembly 26 and the first and second circular disks 42, 58 as the current collectors advantageously.

Further, the first and second circular disks 42, 58 tightly contact the entire electrode surfaces of the electrolyte electrode assembly 26 with the uniform surface pressure. The contact resistances of the current collectors are reduced. Thus, improvement in the power generation efficiency is achieved easily.

Further, the third plate 36 divides the space between the first and second plates 32, 34 for separating the fuel gas and the oxygen-containing gas without any leakage. Thus, improvement in the power generation efficiency is achieved easily. Further, the fuel gas and the oxygen-containing gas flow into the central regions of the anode 24 and the cathode 22, respectively. Therefore, the fuel gas and the oxygen-containing gas are utilized effectively, and the gas utilization ratios are improved.

Further, the exhaust gas channel 48 is formed around the respective electrolyte electrode assemblies 26 in the separators 30. Thus, the heat of the exhaust gas discharged into the exhaust gas channel 48 is utilized to warm the electrolyte electrode assemblies 26. Thus, improvement in the thermal efficiency is achieved easily.

Further, a plurality of the first and second protrusions 50, 60 are provided on the first and second circular disks 42, 58 as the current collectors. Therefore, improvement in the efficiency of collecting the electric energy is achieved. Further, the third protrusions 74 protruding toward the first plate 32 are provided on the third plate 36. Therefore, though the pressure in the oxygen-containing gas channel 90 is higher than the pressure in the fuel gas channel 76, distortion or deformation does not occur in the third plate 36, and thus, the shape of the fuel gas channel 76 is maintained, and the fuel gas is supplied stably. Further, the internal pressures in the respective chambers 88, 92 are increased, and the pressure chambers 88, 92 are expanded to generate pressure load to press the electrolyte electrode assemblies 26. Therefore, the required surface pressure is generated for tightening the electrolyte electrode assemblies 26 without any external tightening means.

Next, a second embodiment according to the present invention will be described.

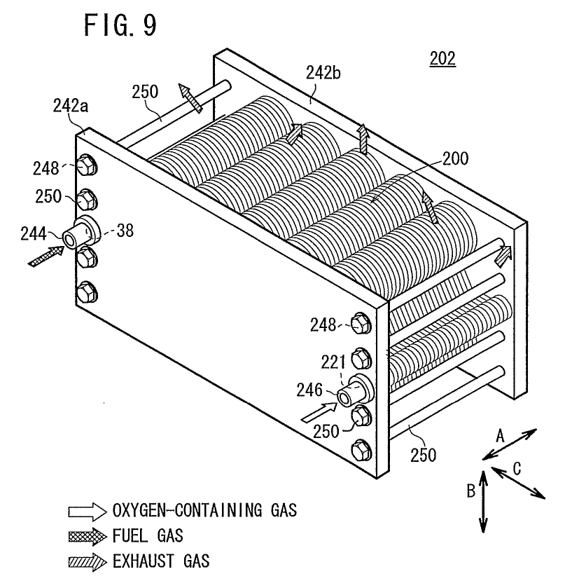

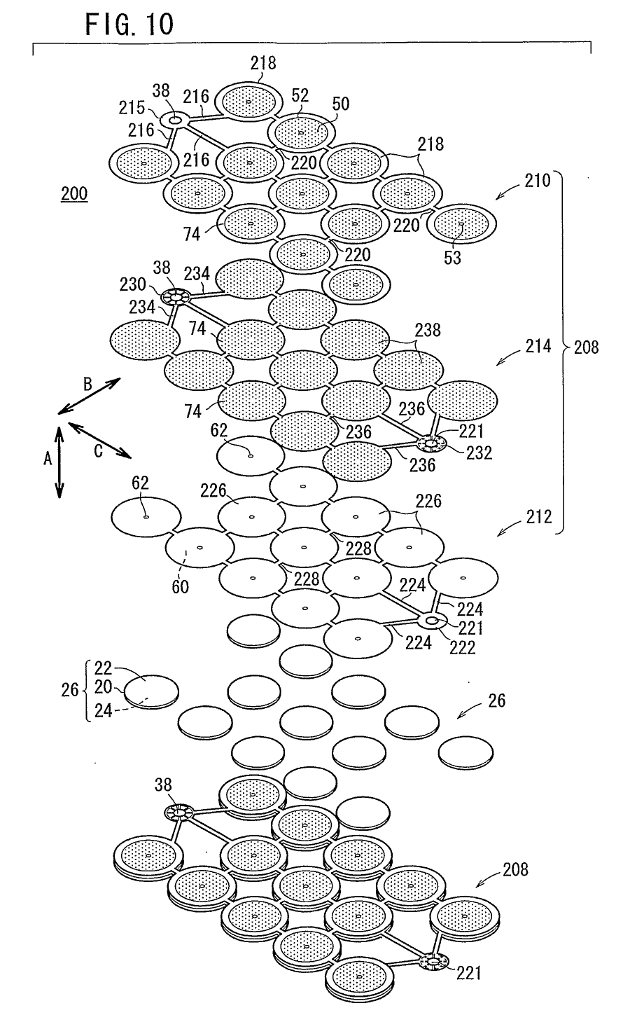

FIG. 9 is a perspective view schematically showing a fuel cell stack 202 formed by stacking a plurality of fuel cells 200 according to a second embodiment invention in a direction indicated by an arrow A. FIG. 10 is an exploded perspective view of the fuel cell 200 in FIG. 9.

In the embodiment, the fuel cell 200 includes thirteen electrolyte electrode assemblies 26. The thirteen electrolyte electrode assemblies 26 are sandwiched between a pair of separators 208.

Each of the separators 208 includes first and second plates 210, 212 which are stacked together, and a third plate 214 interposed between the first and second plates 210, 212. For example, the first through third plates 210, 212, 214 are metal plates of, e.g., stainless alloy.

A first small diameter end portion 215 is provided at one end of the first plate 210. A fuel gas supply passage 38 extends through the center of the first small diameter end portion 215. Three narrow bridges 216 extend radially from the first small diameter end portion 215. Among the three narrow bridges 216, two bridges 216 which are slanted to a direction indicated by an arrow C perpendicular to the stacking direction indicated by the arrow A are integral with first circular disks 218. These first circular disks 218 and the first small diameter end portion 215 are positioned at vertices of a virtual isosceles triangle.

Further, the first circular disks 218 are arranged in three rows in the direction indicated by the arrow C perpendicular to the direction indicated by the arrow A. Five first circular disks 218 are arranged in each of the two outer rows. Three first circular disks 218 are arranged in the middle row between the two outer rows. The first small diameter end portion 215 is connected to the nearest one of the first circular disks 218 (the first circular disk 218 at the head) in the middle row through a bridge 216 extending from the first small diameter end portion 215 in the direction indicated by the arrow C.

Adjacent first circular disks 218 are connected with each other by bridges 220 extending in the direction indicated by the arrow B or the direction indicated by the arrow C.

Each of the first circular disks 218 has a plurality of first protrusions 50 and a ring shaped protrusion 52 on a surface which contacts the anode 24 of the electrolyte electrode assembly 26. Further, a fuel gas inlet 53 is provided at the center in the surface of the first circular disk 218.

The second metal plate 212 has a second small diameter end portion 222. An oxygen-containing gas supply passage 221 extends through the center of the second small diameter end portion 222. Three narrow bridges 224 extend radially from the second small diameter end portion 222. The second small diameter end portion 222 is integral with second circular disks 226 through the three bridges 224. The second circular disks 226 are arranged in three rows in the direction indicated by the arrow B. The second small diameter end portion 222 is provided at the other end of the second plate 212, oppositely to the first small diameter end portion 215.

The second circular disks 226 are provided at positions corresponding to the positions of the first circular disks 218, and the number of the second circular disks 226 is thirteen in total. Adjacent second circular disks 226 are connected with each other by bridges 228 extending in the direction indicated by the arrow B or the direction indicated by the arrow C. Each of the second circular disks 226 has a plurality of first protrusions 60 on a surface which contacts the cathode 22. Further, an oxygen-containing gas inlet 62 is provided at the center in the surface of the second circular disk 226.

The third plate 214 has a third small diameter end portion 230 and a fourth small diameter end portion 232 at opposite ends. The fuel gas supply passage 38 extends through the third small diameter end portion 230, and the oxygen-containing gas supply passage 221 extends through the fourth small diameter end portion 232. The third small diameter end portion 230 and the fourth small diameter end portion 232 are connected to third circular disks 238 through bridges 234, 236, respectively. The third circular disks 238 are provided at positions corresponding to the positions of the first circular disks 218 and the second circular disks 226. Each of the third circular disks 238 has a plurality of third protrusions 74 on a surface facing the first plate 210.

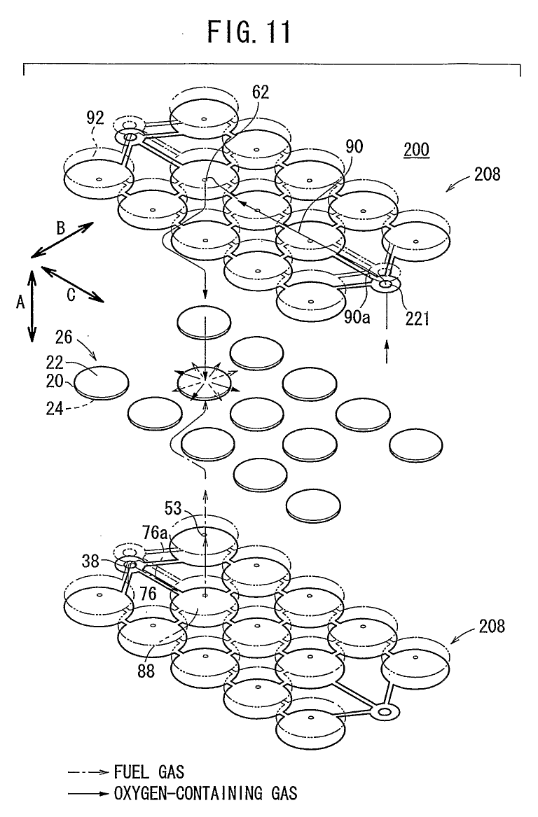

The first plate 210 is joined to the third plate 214, e.g., by brazing to form a fuel gas channel 76 between the first plate 210 and the third plate 214 as shown in FIG. 11. The fuel gas channel 76 includes a fuel gas distribution passage 76a formed between the bridges 216, 234, and a fuel gas pressure chamber 88 formed between the first circular disk 218 and the third circular disk 238.

Likewise, the second plate 212 is joined to the third plate 214, e.g., by brazing to form an oxygen-containing gas channel 90 between the second plate 212 and the third plate 214. The oxygen-containing gas channel 90 includes an oxygen-containing gas distribution passage 90a formed between the bridges 224, 236, and an oxygen-containing gas pressure chamber 92 formed between the second circular disk 226 and the third circular disk 238.

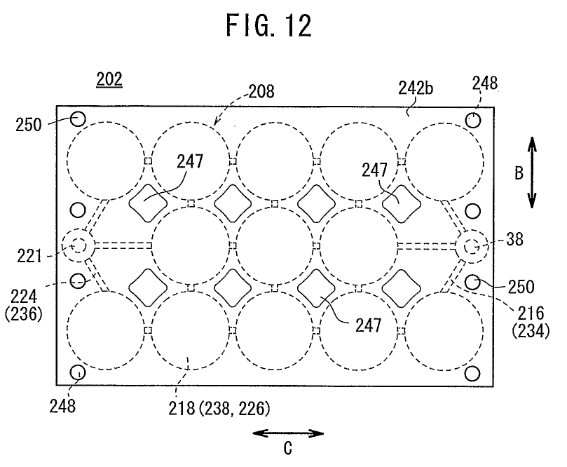

As shown in FIG. 9, the fuel cell stack 202 includes rectangular end plates 242a, 242b provided at opposite ends of the fuel cells 200 in the stacking direction indicated by the arrow A. A first pipe 244 and a second pipe 246 extend through the end plate 242a. The first pipe 244 is connected to the fuel gas supply passage 38, and the second pipe 246 is connected to the oxygen-containing gas supply passage 221. Further, as shown in FIG. 12, the end plate 242b has exhaust holes 247.

The end plates 242a, 242b have bolt insertion holes 248. The fuel gas supply passage 38 and the oxygen-containing gas supply passage 221 are positioned between the bolt insertion holes 248. The bridges 216 connecting the oxygen-containing gas supply passage 38 and the first circular disks 218 in the outer rows and the bridges 224 connecting the oxygen-containing gas supply passage 221 and the second circular disks 226 in the outer rows are slanted in the direction indicated by the arrow B, and the positions of the bolt insertion holes 248 are determined such that bolts 250 are inserted through the bolt insertion holes 248 into positions where the bridges 220, 224 are not present.

The end plate 242a or the end plate 242b are electrically insulated from the bolts 250. The bolts 250 are inserted into the bolt insertion holes 248, and tip ends of the bolts 250 are screwed into nuts to tighten the fuel cell stack 202.

In the fuel cell stack 202 according to the second embodiment, the first plate 210 and the third plate 214 are joined together to form the fuel gas pressure chamber 88 between the first circular disk 218 and the third circular disk 238, and the second plate 212 and the third plate 214 are jointed together to form the oxygen-containing gas pressure chamber 92 between the second circular disk 226 and the third circular disk 238 (see FIG. 11).

Therefore, when the fuel gas supplied from the fuel gas supply passage 38 to the fuel gas channel 76 flows into the fuel gas pressure chamber 88, the internal pressure in the fuel gas pressure chamber 88 is increased, and the fuel gas chamber 88 is expanded such that the first circular disk 218 tightly contacts the entire electrode surface of the anode 24 of the electrolyte electrode assembly 26 under pressure. Likewise, when the oxygen-containing gas supplied from the oxygen-containing gas supply passage 221 to the oxygen-containing gas channel 90 flows into the oxygen-containing gas pressure chamber 92, the internal pressure in the oxygen-containing gas pressure chamber 92 is increased, and the oxygen-containing gas chamber 92 is expanded such that the second circular disk 226 tightly contacts the entire electrode surface of the cathode 22 under pressure.

Therefore, the same advantages as with the first embodiment can be obtained. For example, with the simple and compact structure, it is possible to maintain the uniform pressure applied between the electrolyte electrode assembly 26 and the first and second circular disks 218, 226 as the current collectors advantageously, and to improve the power generator efficiency easily.

Further, since the fuel cell stack 202 has a substantially rectangular parallelepiped shape (box shape), the fuel cell stack 202 can be mounted stably, and it is possible to place the fuel cell stack 202 in the casing easily. Therefore, the fuel cell system can be produced easily.

Further, since the exhaust gas from each of the electrolyte electrode assemblies 26 is discharged to the outside of the fuel cell stack 202 through the exhaust holes 247 of the end plate 242b, improvement in the discharging efficiency is achieved.

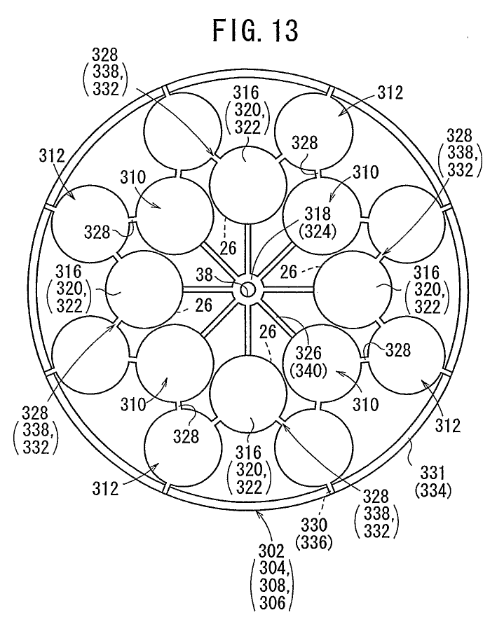

Next, a fuel cell according to a third embodiment will be described with reference to a plan view of the fuel cell in FIG. 13. The fuel cell 300 has a separator 302 including a first plate 304, a second plate 306, and a third plate 308 interposed between the first plate 304 and the second plate 306.

In the plan view of FIG. 13, the third plate 308 is stacked on the first plate 304, and the second plate 306 is stacked on the third plate 308. The fuel cell 300 includes eight inner unit cells 310 and eight outer unit cells 312 provided around the inner unit cells 310. The inner unit cells 310 are arranged along a virtual circle at equal angles. The outer unit cells 312 are concentric with the inner unit cells 310. In each of the inner unit cells 310 and the outer unit cells 312, an electrolyte electrode assembly 26 (see FIGS. 3 and 10) is interposed between a pair of separators 302.

First circular disks 316 and a first small diameter end portion 318 of the first plate 304, and second circular disks 320 of the second plate 306, and third circular disks 322 and a second small diameter end portion 324 of the third plate 308 have the same structure as the first circular disks 42, 218, the first small diameter end portions 40, 215, the second circular disks 58, 226, the third circular disks 66, 238, and the second small diameter end portions 64, 222 according to the first and second embodiments, and therefore, detailed description thereof is omitted.

In the embodiment, the first small diameter end portion 318 of the first plate 304 and the second small diameter end portion 324 of the third plate 308 are provided at the center of the concentric circle, and stacked together. A fuel gas supply passage 38 extends through the center of the first small diameter end portion 318. Further, bridges 326 extend radially from the first small diameter end portion 318. The first circular disks 316 of the inner unit cells 310 are connected to the first small diameter end portion 318 by the bridges 326.

The first circular disks 316 of the outer unit cells 312 are provided outside positions between adjacent circular disks 316 of the inner unit cells 310. Each of the first circular disks 316 of the outer unit cells 312 is connected to the two adjacent first circular disks 316 of the inner unit cells 310 by bridges 328.

In the second plate 306, the second circular disks 320 of the outer unit cells 312 are connected to an annular outer section 331 by bridges 330. The second circular disks 320 of the outer unit cells 312 are connected to second circular disks 320 of the inner unit cells 310 by bridges 332. That is, the bridges 332 are provided at positions corresponding to the positions of the bridges 328.

An annular outer section 334 of the third plate 308 has a plurality of slits as air intake passages at positions corresponding to the third circular disks 322 of the outer unit cells 312, on a surface facing the second plate 306. Further, a recess for preventing the flow of brazing material is formed along the annular outer section 334.

The third circular disks 322 of the outer unit cells 312 are connected to the annular outer section 334 through bridges 336. Further, the third circular disks 322 of the outer unit cells 312 are connected to third circular disks 322 of the inner unit cells 310 by bridges 338 provided at positions corresponding to the positions of the bridges 328, 332.

Further, the second small diameter end portion 324 is connected to the third circular disks 322 of the inner unit cells 310 by bridges 340 provided at positions corresponding to the positions of the bridges 326.

As described above, the fuel cell 300 according to the third embodiment includes a large number of the unit cells 310, 312. Therefore, the above described advantages can be obtained, and a large amount of electric energy is generated in the fuel cell 300 advantageously.

Further, since the inner unit cells 310 are concentric with the outer unit cells 312, the temperature of the fuel cell 300 is substantially the uniform in the radial direction. Stated otherwise, the temperature difference does not occur significantly in the radial direction of the fuel cell 300. Thus, it is possible to prevent the difference in thermal expansion between the inner unit cells 310 and the outer unit cells 312. As a result, it is possible to prevent components such as the first through third plates 304, 306, 308 from being damaged due to the thermal expansion difference between the inner unit cells 310 and the outer unit cells 312.

It is a matter of course that a plurality of the fuel cells 300 can be stacked together to form a fuel cell stack.

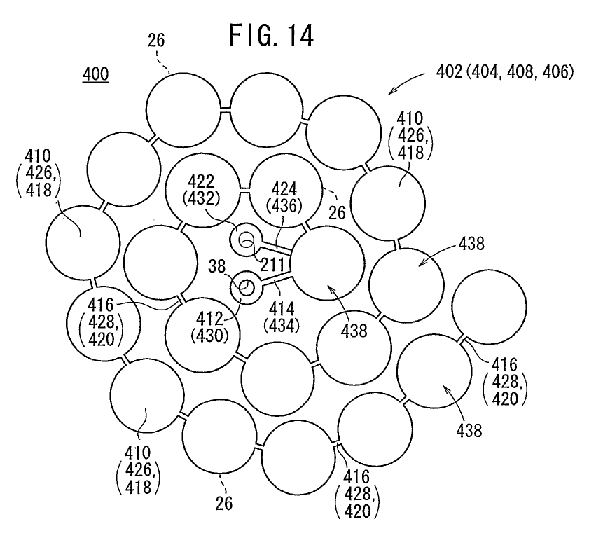

Next, a fuel cell according to a fourth embodiment will be described with reference to a plan view of the fuel cell in FIG. 14. The fuel cell 400 has a separator 402 including a first plate 404, a second plate 406, and a third plate 408 interposed between the first plate 404 and the second plate 406.

In the fourth embodiment, the first plate 404 includes a plurality of first circular disks 410 and a first small diameter end portion 412. The first circular disks 410 have the same structure as the first circular disks 42, 218, 316 according to the first through third embodiments, and arranged in a spiral pattern. The first small diameter end portion 412 is connected to one of the first circular disks 410 by a bridge 414. The first circular disks 410 are connected with each other by bridges 416.

Further, the second plate 406 includes a plurality of second circular disks 418. The second circular disks 418 have the same structure as the second circular disks 58, 226, 320 according to the first through third embodiments, and are arranged at positions corresponding to the positions of the first circular disks 410. The second circular disks 418 are connected with each other by bridges 420.

One of the second circular disks 418 is connected to a second small diameter end portion 422 having the same structure as the second small diameter end portion 222 by a bridge 424.

The third plate 408 has third circular disks 426 interposed between the first circular disks 410 and the second circular disks 418. The third circular disks 426 have the same structure as the third circular disks 66, 238, 322 according to the first through third embodiments. That is, the third circular disks 426 are arranged in a spiral pattern, and connected by bridges 428 provided at positions corresponding to the positions of the bridges 416, 420.

The third plate 408 has a third small diameter end portion 430 and a fourth small diameter end portion 432. As shown in FIG. 10, the third small diameter end portion 430 has the same structure as the third small diameter end portion 230, and the fourth small diameter end portion 432 has the same structure as the fourth small diameter end portion 232. The third small diameter end portion 430 is connected to one of the third circular disks 426 by a bridge 434, and the fourth small diameter end portion 432 is connected to one of the third circular disks 426 by a bridge 436.

When the first through third plates 404, 406, 408 are stacked together, the first small diameter end portion 412 and the third small diameter end portion 430 are stacked together, the second small diameter end portion 422 and the fourth small diameter end portion 432 are stacked together, the bridges 414, 434 are stacked together, and the bridges 424, 436 are stacked together to form the fuel gas channel and the oxygen-containing gas channel. One of the fuel gas channel and the oxygen-containing gas channel is slightly deviated from the axis in the stacking direction of the fuel cell 400. Therefore, the fuel gas supply passage 38 is also slightly deviated from the axis of the oxygen-containing gas supply passage 221.

The electrolyte electrode assemblies 26 (see FIGS. 3 and 10) are interposed between the separators 402 having the above structure. Thus, the fuel cell 400 includes unit cells 438 which are connected in a spiral pattern. A plurality of the fuel cells 400 are stacked together to form a fuel cell stack.

By increasing the number of the unit cells 438 which are connected in a spiral pattern, it is possible to reduce the thickness of the fuel cell stack in the stacking direction. Therefore, the space needed for installation of the fuel cell stack is reduced. That is, in the fuel cell 400 according to the fourth embodiment of the present invention, the advantages as described above can be obtained. Further, since the inlets for supplying the fuel gas and the oxygen-containing gas are provided in central regions of the unit cells 438 which are connected in a spiral pattern, it is possible to supply preheated reactant gases to the fuel cell stack. Thus, improvement in the thermal efficiency is improved, and a large amount of electric energy is generated in the fuel cell stack with the small thickness in the stacking direction advantageously.

In the first through fourth embodiments, only one fuel gas channel is provided. In the first and third embodiments, since the air as the oxygen-containing gas is taken from the outside of the fuel cell stack (see FIG. 1), it is not required to provide any oxygen-containing gas channel particularly. Further, in the second and fourth embodiments, only one oxygen-containing gas channel is provided. As described above, in the present invention, only one reactant gas channel (one fuel gas channel and one oxygen-containing gas channel) is sufficient. Therefore, the amount of material used for the seal member for preventing the leakage of the reactant gas is reduced. Further, at the time of assembling the fuel cell, the load is focused on the seal member. Thus, improvement in the sealing performance is achieved, and the gas utilization ratios are improved.

While the invention has been particularly shown and described with reference to preferred embodiments, it will be understood that variations and modifications can be effected thereto by those skilled in the art without departing from the spirit and scope of the invention as defined by the appended claims.

1. A fuel cell comprising a plurality of electrolyte electrode assemblies sandwiched between a pair of separators, said electrolyte electrode assemblies each including an anode, a cathode, and an electrolyte interposed between said anode and said cathode, wherein
each of said separators includes first and second plates which are stacked together;
a fuel gas channel for supplying a fuel gas to said anode, and an oxygen-containing gas channel for supplying an oxygen-containing gas to said cathode are formed between said first and second plates;
said fuel gas channel is provided over an electrode surface of said anode, and said first plate is interposed between said fuel gas channel and said anode to form a fuel gas pressure chamber such that said first plate tightly contacts said anode under pressure when said fuel gas is supplied into said fuel gas pressure chamber;
said oxygen-containing gas channel is provided over an electrode surface of said cathode, and said second plate is interposed between said oxygen-containing gas channel and said cathode to form an oxygen-containing gas pressure chamber such that said second plate tightly contacts said cathode under pressure when said oxygen-containing gas is supplied into said oxygen-containing gas pressure chamber; and
said fuel gas is supplied individually to the respective anodes of said electrolyte electrode assemblies, and said oxygen-containing gas is supplied individually to the respective cathodes of said electrolyte electrode assemblies.

2. A fuel cell according to claim 1, wherein a plurality of said fuel gas pressure chambers and a plurality of said oxygen-containing gas pressure chambers corresponding to the number of said electrolyte electrode assemblies are provided individually, and adjacent fuel gas pressure chambers or adjacent oxygen-containing gas pressure chambers are connected with each other; and
said electrolyte electrode assemblies are provided separately at positions of said fuel gas pressure chambers and said oxygen-containing gas pressure chambers.

3. A fuel cell according to claim 1, wherein said first plate has a fuel gas inlet for supplying said fuel gas from said fuel gas pressure chamber toward a central region of said anode; and
said second plate has an oxygen-containing gas inlet for supplying said oxygen-containing gas from said oxygen-containing gas pressure chamber toward a central region of said cathode.

4. A fuel cell according to claim 1, wherein a third plate is provided between said first and second plates for dividing a space between said first and said second plates into said fuel gas channel and said oxygen-containing gas channel.

5. A fuel cell according to claim 4, wherein a fuel gas distribution passage for connecting a fuel gas supply passage and said fuel gas channel is formed between said first and third plates, and said fuel gas before consumption is supplied through said fuel gas supply passage in a stacking direction of said electrolyte electrode assemblies and said separators; and
an oxygen-containing gas distribution passage for connecting an oxygen-containing gas supply passage and said oxygen-containing gas channel is formed between said second and third plates, and said oxygen-containing gas before consumption is supplied through said oxygen-containing gas supply passage in the stacking direction.

6. A fuel cell according to claim 1, wherein each of said separators further comprises an exhaust gas channel for discharging said oxygen-containing gas and said fuel gas supplied to, and consumed in reactions in said electrolyte electrode assemblies as an exhaust gas in the stacking direction of said electrolyte electrode assemblies and said separators; and
a fuel gas channel member for forming said fuel gas channel and supporting each of said electrolyte electrode assemblies, and an oxygen-containing gas channel member for forming said oxygen-containing gas channel and supporting each of said electrolyte electrode assemblies are provided in said exhaust gas channel.

7. A fuel cell according to claim 1, wherein said first and second plates include first and second protrusions protruding in different directions; and
said first protrusion of one of said separators and said second protrusion of the other of said separators sandwich each of said electrolyte electrode assemblies.

8. A fuel cell according to claim 7, wherein said first and second protrusions function as current collectors for collecting electric energy generated in each of said electrolyte electrode assemblies.

9. A fuel cell according to claim 7, wherein said third plate has a third protrusion protruding toward said first plate.

10. A fuel cell stack including a plurality of fuel cells stacked together, and end plates provided at opposite ends in a stacking direction of said fuel cells, said fuel cells each formed by sandwiching a plurality of electrolyte electrode assemblies between a pair of separators, said electrolyte electrode assemblies each including an anode, a cathode, and an electrolyte interposed between said anode and said cathode, wherein
each of said separators includes first and second plates which are stacked together;
a fuel gas channel for supplying a fuel gas to said anode, and an oxygen-containing gas channel for supplying an oxygen-containing gas to said cathode are formed between said first and second plates;
said fuel gas channel is provided over an electrode surface of said anode, and said first plate is interposed between said fuel gas channel and said anode to form a fuel gas pressure chamber such that said first plate tightly contacts said anode under pressure when said fuel gas is supplied into said fuel gas pressure chamber;
said oxygen-containing gas channel is provided over an electrode surface of said cathode, and said second plate is interposed between said oxygen-containing gas channel and said cathode to form an oxygen-containing gas pressure chamber such that said second plate tightly contacts said cathode under pressure when said oxygen-containing gas is supplied into said oxygen-containing gas pressure chamber; and
said fuel gas is supplied individually to the respective anodes of said electrolyte electrode assemblies, and said oxygen-containing gas is supplied individually to the respective cathodes of said electrolyte electrode assemblies.

11. A fuel cell stack according to claim 10, wherein a plurality of said fuel gas pressure chambers and a plurality of said oxygen-containing gas pressure chambers corresponding to the number of said electrolyte electrode assemblies are provided individually, and adjacent fuel gas pressure chambers or adjacent oxygen-containing gas pressure chambers are connected with each other; and
said electrolyte electrode assemblies are provided separately at positions of said fuel gas pressure chambers and said oxygen-containing gas pressure chambers.
